(19) United States
(12) Patent Application Publication
(10) Pub. No.: US 2016/0023552 A1
(43) Pub. Date: Jan. 28, 2016

(54) CENTER CONSOLE ARRANGEMENT FOR A MOTOR VEHICLE

(71) Applicant: DR. ING. H.C. F. PORSCHE AKTIENGESELLSCHAFT, Stuttgart (DE)

(72) Inventors: Thomas MIM, Leonberg (DE); Lutz KRAUSS, Karlsruhe (DE); Alexander BOGNER, Ditzingen (DE); Franz-Josef SIEGERT, Herrenberg (DE); Anke WILHELM, Stuttgart (DE); Rolf HARTMANN, Stuttgart (DE)

(21) Appl. No.: 14/773,395

(22) PCT Filed: Feb. 22, 2014
(86) PCT No.: PCT/EP2014/000473

§ 371 Date: Sep. 8, 2015

(30) Foreign Application Priority Data
Mar. 13, 2013 (DE) 10 2013 102 495.5

(51) Int. Cl. B60K 35/00; B60K 37/06; B60K 37/02

(52) U.S. Cl. CPC B60K 35/00; B60K 37/02; B60K 37/06; B60K 2350/1028; B60K 2350/1036; B60K 2350/925

(57) ABSTRACT

A center console arrangement for a motor vehicle includes a housing arrangement with at least one cover surface arranged thereon. The cover surface includes at least two functional regions. Each functional regions includes at least one display and/or operator control panel. Each of the display and/or operator control panels is assigned, with respect to functionality, to the corresponding functional region.

### CROSS REFERENCE TO RELATED APPLICATIONS

This application is a U.S. National Phase application under 35 U.S.C. §371 of International Application No. PCT/EP2014/000473, filed on Feb. 22, 2014, and claims benefit to German Patent Application No. DE 10 2013 102 495.5, filed on Mar. 13, 2013. The International Application was published in German on Sep. 18, 2014 as WO 2014/139637 A1 under PCT Article 21 (2).

### FIELD

The invention relates to a center console arrangement for a motor vehicle having a housing arrangement in which at least one cover surface, which has a number of elements such as, for example, storage surfaces, operator control switches etc., is arranged.

### BACKGROUND

Such center console arrangements are sufficiently known. For example DE 197 37 739 B4 describes a center console arrangement of modular design for a motor vehicle, in which center console arrangement various elements such as, for example, a drinks vessel holder, a storage recess or the like are positioned with connecting elements in a housing arrangement of the center console arrangement. Furthermore, from the prior art it is sufficiently known to use screen surfaces which are fixedly arranged in the dashboard and by means of which the vehicle information or air conditioning information can be retrieved and which, furthermore, can be used as a navigation device. Although such concepts basically permit the driver to retrieve a large amount of information, the menu prompting and the proliferation of submenus in most cases are disadvantageous with respect to rapid access and clear, simple recognition of the menus.

### SUMMARY

In an embodiment, the present invention provides a center console arrangement for a motor vehicle including a housing arrangement with at least one cover surface arranged thereon. The cover surface includes at least two functional regions. Each of the functional regions includes at least one display and/or operator control panel. Each of the display and/or operator control panels is assigned, with respect to functionality, to the corresponding functional region.

### BRIEF DESCRIPTION OF THE DRAWINGS

The present invention will be described in even greater detail below based on the exemplary FIGURE. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawing which illustrates the following:

FIG. 1 shows a perspective arrangement of a center console arrangement according to an embodiment of the invention

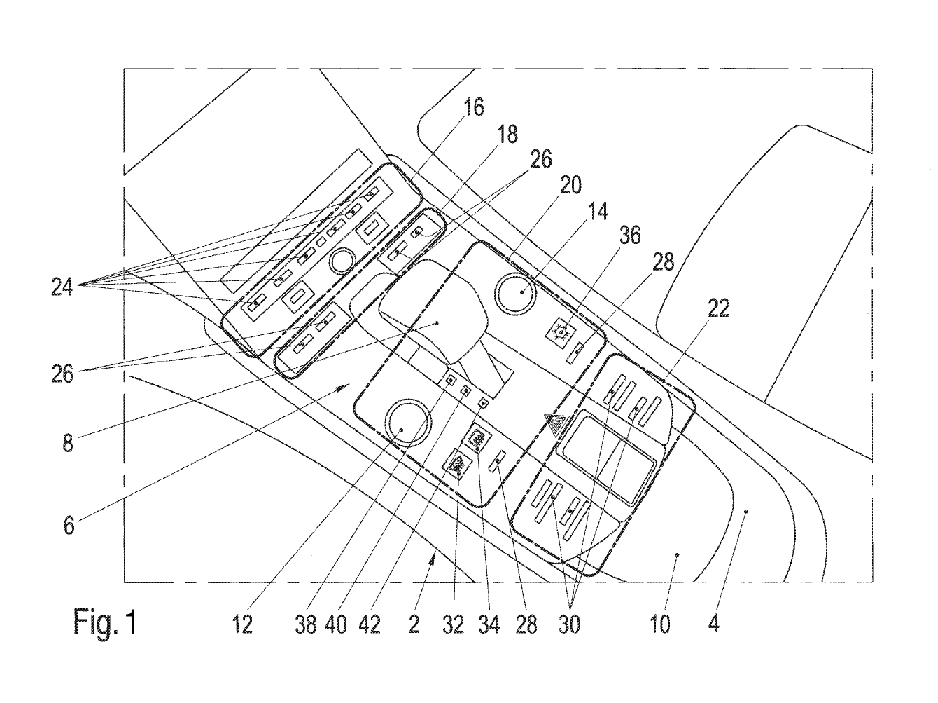

### DETAILED DESCRIPTION

An aspect of the invention is to avoid the abovementioned disadvantage and to permit the user to have direct access to the most important information and/or operator control elements with simple means and high design quality.

In an embodiment, the present invention provides a cover surface that has at least two functional regions in each of which display and/or operator control panels are arranged. A display panel can advantageously also be embodied at the same time as an operator control panel. In one advantageous embodiment, the cover surface has four functional regions such as infotainment, performance, air conditioning and vehicle functions. Through this thematic and functional separation the driver can make a rapid and targeted selection of the individual operator control elements.

The operator control can also be simplified by virtue of the fact that the cover surface is embodied at least partially as a screen surface which has at least one functional region. It is particularly advantageous here if the screen surface is embodied at least partially as a touch screen surface.

In an embodiment, a shift lever can be provided, wherein the transmission setting information is embodied as display panels in the cover surface.

Furthermore, selector switches, selector levers and/or rotational selector elements for actuating vehicle functions or for menu-controlled selection can be provided as elements. This is advantageous, in particular, when the vehicle also has a menu-controlled screen surface in the dashboard.

In order to ensure the best possible personal adaptation, the display panels and operator control panels can be embodied in such a way that they can be faded in and out. As a result of the fact that the functional regions are separated from one another by three-dimensional shaped elements such as, for example, grooves, bead-shaped edge regions etc., simple differentiation is possible. It is also conceivable for the functional regions to have different coloring in the form of a border or colored background.

The single figure shows a center console arrangement 2 for a motor vehicle having a housing arrangement 4, wherein this housing arrangement has a cover surface 6 in the upper region. This cover surface is divided into various regions, wherein each region is assigned to a functionality in the vehicle. In addition to this cover surface 6, a shift lever 8, a storage recess 10 and two rotational selector elements 12, 14 are also provided as elements on the housing arrangement.

The cover surface 6 has essentially four functional regions 16, 18, 20, 22. The functional region 16 is reserved here for the “infotainment” region, the functional region 18 for the “motor vehicle performance” region, the functional region 20 for the “air conditioning” region, and the functional region 22 for the “vehicle information” region. Here, each functional region has a number of display panels 24, 26, 28, 30. In this context, the display panels 24 of the “infotainment” functional region 16 can specify, for example, the number of a selected song of a CD or else also the radio station. The display panels 26 of the “performance” functional region 18 can represent specific performance data of the vehicle such as, for example, the torque. Furthermore, operator control panels 32, 34, 36 can also be provided (here in the “air conditioning” functional region 20), wherein the operator control panel 32 is assigned to the windshield heater, the operator control panel 34 to the rear window heater and the operator control panel 36 to the vehicle ventilation system. In order to permit the operator control panels 32, 34, 36 to be embodied in a convenient way, the screen surface 6 is embodied as a touch screen surface in this region.

As already indicated, a shift lever 8 is provided in a known fashion, wherein transmission setting information 38, 40, 42 is also embodied here as display panels in the cover surface 6. The rotational selector elements 12, 14 which have already been mentioned serve for the menu-controlled selection of a display (not illustrated further) in the dashboard. As a result, for example a navigation device can be actuated. Certain display panels can be embodied in such a way that they can be faded in and out, in order, for example, to avoid making all the information available to a front seat passenger. Furthermore, the display panels per se or lettering on the display panels or a symbolic representation of the display panels or else a border around the functional regions 16, 18, 20, 22 can be embodied in color or have a colored background in order to ensure even simpler assignment. In this context, the border can also be embodied in a three-dimensional fashion.

It should be clear that information and operator control elements are made accessible more conveniently to the user of a motor vehicle in this simple and cost-effective manner with high design quality.

A primary feature of the arrangement according to embodiments of the invention is the apportioning or assignment of the individual operator control elements to various logical functional groups.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1-9. (canceled)

10. A center console arrangement for a motor vehicle, comprising:
a housing arrangement;
at least one cover surface arranged on the housing arrangement, the cover surface including at least two functional regions, each of the functional regions including at least one display and/or operator control panel, each of the display and/or operator control panels being assigned, with respect to functionality, to the corresponding functional region.

11. The center console arrangement as recited in claim 10, wherein the cover surface has four functional regions.

12. The center console arrangement as recited in claim 11, wherein the four functional regions include at least one of infotainment, performance, air conditioning or vehicle functions.

13. The center console arrangement as recited in claim 11, wherein the four functional regions include infotainment, performance, air conditioning and vehicle functions.

14. The center console arrangement as recited claim 10, wherein at least a portion of the cover surface includes a screen surface which has at least one functional region.

15. The center console arrangement as recited in claim 12, wherein at least a portion of the screen surface is a touch screen surface.

16. The center console arrangement as recited in claim 10, further comprising a shift lever, and wherein transmission setting information is embodied as display panels in the cover surface.

17. The center console arrangement as recited in claim 10, wherein at least one of selector switches, selector levers or rotational selector elements for actuating vehicle functions or for menu-controlled selection are provided as elements.

18. The center console arrangement as recited in claim 10, wherein the display panels and operator control panels are configured to be faded in and out.

19. The center console arrangement as recited in claim 10, wherein the functional regions have clear division from one another and, for simple assignment, are separated from one another by three-dimensional shaped elements.

20. The center console arrangement as recited in claim 19, where the three-dimensional shaped elements include at least one of grooves or bead-shaped edge regions.

21. The center console arrangement as recited in claim 10, wherein the functional regions have different coloring in the form of at least one of a border or colored background.
